(19) United States
(12) Patent Application Publication
(10) Pub. No.: US 2018/0220606 A1
(43) Pub. Date: Aug. 9, 2018

(54) COMBINATION TIERED MODULAR KIT ASSEMBLY INCLUDING HYDROPONIC BASKET FOR GROWING PLANTS IN A BUCKET

(71) Applicant: Kevin M. Daniel, Port Huron, MI (US)

(72) Inventor: Kevin M. Daniel, Port Huron, MI (US)

(21) Appl. No.: 15/948,288

(22) Filed: Apr. 9, 2018

Related U.S. Application Data
(63) Continuation-in-part of application No. 15/385,413, filed on Dec. 20, 2016.
(60) Provisional application No. 62/484,662, filed on Apr. 12, 2017.
(60) Provisional application No. 62/272,563, filed on Dec. 29, 2015.

(51) Int. Cl. A01G 31/02

(52) U.S. Cl. CPC A01G 31/02

(57) ABSTRACT

A kit for providing stem, branch and foliage support for a hydroponic planting, the kit being supported upon a rim of a bucket and including at least one hoop shaped component exhibiting an open interior. A basket is supported by the hook shaped component so that an apertured and depth extending portion of the basket extends downwardly past its open interior. A plurality of aggregate, along with a seedling, is placed within the basket aperture interior so that the same is immersed in a liquid filling an interior of the bucket. The hoop shaped components exhibit vertically extending and elongated tier defining portions arranged in perimeter defined fashion about the component. Each of the tier defining portions have upper and lower inter-engaging locations and allowing for stacking of any additional number of components in vertically spaced apart and tiered defining fashion.

### CROSS REFERENCE TO RELATED APPLICATIONS

The present application claims the priority of U.S. Ser. No. 62/484,662 filed Apr. 12, 2017. The present application also claims the priority of U.S. Ser. No. 15/385,413, filed Dec. 20, 2016. The '413 application claims the priority of U.S. Ser. No. 62/272,563 filed Dec. 29, 2015.

### FIELD OF THE INVENTION

The present invention relates generally to a modular plant support kit and assembly. More particularly, the present invention teaches such a kit and assembly incorporating a plurality of hoop shaped components which can be arranged in vertically ascending/tiered fashion in order to support the stem of a growing plant.

Additionally, the invention applies to an improved and modified modular kit assembly in particular use with hydroponic growing operations. The kit assembly includes a colander like basket having perforated sides and or bottom and which includes an annular upper lip which permits the basket to be supported about a rim of a lower-most positioned hoop shaped component (or which can be integrated into a single piece construction)

The basket and hoop can be supported (including being snap engaged) upon a standard three or five gallon bucket. The colander or “basket” is filled with a stone media, with a seedling inserted into the stone media. The outer supporting bucket is filled with a water/nutrient mixture (no dirt required) and, with the basket suspended within the nutrient liquid mixture, allowing the seedling to grow hydroponically with additional tier defining hoops being added as necessary to provide an effective hydroponic support system. This can be used in both traditional vegetables, flowers and the medicinal communities.

### BACKGROUND OF THE INVENTION

The prior art is documented with various examples of stackable or module plant support structures. The purpose of such structures or assemblies is to provide a vertically ascending or tiered support to a growing plant stem.

A first example from the prior art is described in U.S. Pat. No. 8,567,120, to Davis et al., which teaches a modular support for vine plants and tomato plants having a solid, cylindrical base with holes to accept posts and associate tier rings. A cover may also be provided to transform the base into a miniature hot house. Notches may be formed in the rim of the base to accommodate irrigation systems and stake ends may be provided for the posts to allow immediate securement of the posts to the ground rather than the base. The solid base contains water, mulch and other beneficial compounds for the plants and helps block the spread of weeds immediately around the plant. As the plant grows, additional tiers may be added to the support to increase its size. The parts are preferably made of a durable plastic so as to support larger plants and increase longevity of the support.

A second example is shown in Wilbanks, Jr. et al., U.S. Pat. No. 7,478,501, which teaches a modular plant support system for supporting growing plants made up of a stacked interlocking layers of cylindrical split rings. The split rings are flexible and modular and configured to interconnect end to end so as to form a plant support layer of any reasonable diameter by coupling multiple sections. The layers of the plant support stand may be stacked and interconnected to form a plant support system of a height suited to support requirements of the plant.

Elliott, U.S. Pat. No. 5,640,802, teaches a support assembly for growing tomato plants which allows ready access to the plant during the various stages of growth by utilizing interchangeable parts. These include post sections having a tapered member (A) on a bottom end and a tapered socket (B) on the other end for joining the sections to form continuous posts having vertically spaced seating locations (C), and horizontal supports (D) having sockets (E) which fit securely onto post sections and spaced vertically to form modules that may be stacked in vertical relation and thereby added progressively to meet the needs engendered by growth of the plant and to permit ready access to the plant.

Brown, US 2015/0113869, teaches a plant growing system which protects plants during spring, for early and/or fast growth, and supports the plants later in the growing season. Frames hold panels that protect the plants by enclosing, shielding, and/or shading the interior growing space, and upon removal of the panels, the frames may support the larger plants and their fruit/vegetables. Multiple cooperating frames pivotally connect to form modular units of various sizes and shapes, and a latching/locking feature may stabilize the unit by preventing accidental disconnection of the frames. The frames may include feature(s) that allow, and stabilize, stacking of multiple units for accommodating taller plants. The panels held by the frames may be translucent/transparent, opaque, or a combination of the two, for customizing the interior environment inside each modular unit to the plant(s), the time of year, and/or the location and climate.

### SUMMARY OF THE INVENTION

The present invention teaches a kit and assembly incorporating a plurality of hoop shaped components for supporting a stem of a plant. Each of the hoop shaped components exhibits a plurality of vertically integrated and elongated tier defining portions arranged in perimeter defined fashion about the hoops, an intermediate location of each of an individual plurality of tier defining portions being integrated into each hoop.

The tier defining portions each exhibit upper and lower inter-engaging locations for stacking any plurality of hoop shaped components in vertically spaced apart and tiered defining fashion. Optional elongated and height extending portions can be interposed between the integrated tier defining portions in order to increase the vertical spacing between respective hoop shaped components.

Each of the hoop shaped components can include a disk shape with an inner perimeter rim edge, and so that a lower-most hoop component can be configured to engage an upper rim location of a plant supporting bucket in a first supporting arrangement. A plurality of feet stakes are provided and, in a second mounting arrangement, can engage the lower engaging locations associated with the bottom most tiered hoop shaped component, the feet stakes being further adapted to embed in a soil location associated with a field or garden planted stem.

An additional aspect of the invention provides the ability to grow various types of plants hydroponically using a related kit assembly which includes a colander like basket having perforated sides and or bottom, and which includes an annular upper lip which permits the basket to be supported about a rim of a lower-most positioned hoop shaped component (or which can be integrated into a single piece construction). The basket and hoop can be supported (including being snap engaged) upon a standard three or five gallon bucket. The colander or “basket” is filled with a stone media, with a seedling inserted into the stone media. The outer supporting bucket is filled with a water/nutrient mixture (no dirt required) and, with the basket suspended within the nutrient liquid mixture, allowing the seedling to grow hydroponically with additional tier defining hoops being added as necessary to provide an effective hydroponic support system. This can be used in both traditional vegetables, flowers and the medicinal communities.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded view of the kit and assembly according to a first variant and which includes a selected hoop shaped component which exhibits a plurality of vertically integrated and elongated tier defining portions arranged in perimeter defined fashion about the hoop, as well as showing elongated and height extending portions interposed between the integrated tier defining portions in order to increase the vertical spacing between respective hoop shaped components and feet stakes engageable with lowermost engaging locations associated with the bottom most tiered hoop shaped component;

FIG. 2 is a front plan view of the exploded embodiment of FIG. 1 and further illustrating, in phantom, a plant bucket having an upper rim location to which a lower-most hoop component can be configured to engage in a further supporting arrangement not requiring the feet stakes;

FIG. 3 is a top plan view of the embodiment of FIGS. 1-2 and illustrating the height extending portions and feet stakes positionally radially outwardly from the perimeter of the hoop shaped component for purposes of clarity of presentation;

FIG. 4 is a ninety degree rotated side plan view of the exploded embodiment of FIG. 2;

FIG. 5 is a bottom plan view of the embodiments of FIGS. 1-4;

FIG. 6 is an assembled perspective view of the modular kit and assembly according to a further variant without use of the intermediate spacers;

FIG. 7 is an exploded perspective view of the kit and assembly shown in FIG. 6;

FIG. 8 is an assembled front plan view of variant of FIG. 6;

FIG. 9 is an assembled perspective view of the modular kit and assembly according to the variant of FIG. 1 with a second tier defining hoop shaped component;

FIG. 10 is an exploded perspective of FIG. 9;

FIG. 11 is a plan view illustration of FIG. 10;

FIG. 12 is a perspective of a further variant of hoop-shaped component exhibiting a partially open profile;

FIG. 13 is an exploded perspective view similar to FIG. 7 of a plurality of interconnecting components as shown in FIG. 12;

FIG. 14 is an illustration of a further variant of a combination tiered modular kit assembly including a lower-most positioned hoop shaped component with a colander like support basket which are supported upon a rim of a conventional bucket;

FIG. 15 is a rotated perspective of the combination colander shaped basket and hoop-shaped according to one non-limiting variant of the present inventions;

FIG. 16 is an assembled view of the modular kit assembly in combination with the colander shaped basket integrated into a lower most of the hoop shaped components and in turn supported upon an upper rim of a standard three or five gallon bucket;

FIG. 17 is a side view of the basket supported in suspended fashion upon the bucket interior;

FIG. 18 is a perspective view of a colander shaped basket according to one non-limiting embodiment of the present inventions and which includes an annular upper rim which can either be integrally affixed to or supported upon the upper surface of the hoop shaped component;

FIG. 19 is a top plan view of the hydroponic colander basket of FIG. 18;

FIG. 20 is an illustration of a one piece combination injection molded hoop and colander basket according to a further variant; and

FIG. 21 is an illustration of a plurality of hoops such as previously depicted in a multiple-stacked and stored configuration in which the integrated stanchion abuts in seating fashion against an exterior facing scalloped recess in an adjoining hoop.

### DETAILED DESCRIPTION OF THE PREFERRED EMBODIMENTS

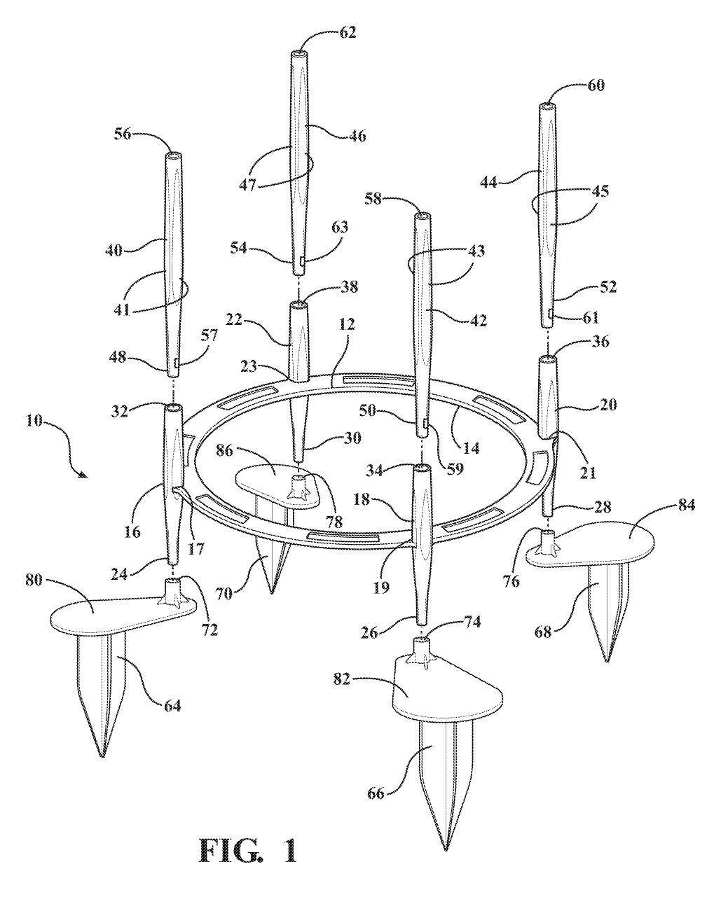

As will be described with reference to FIGS. 1-11 below, the present invention teaches a kit and assembly incorporating a plurality of hoop shaped components for supporting a stem of a plant. The kit can be reconfigured in a number of different ways in order to provide constraining support to the stem, branches and foliage of a growing planting (generally identified to include any of a tree, shrub or plant). The modular nature of the kit is further such that it can be easily tiered or stacked in order to track the growth of the planting, and for as long as is necessary to provide the desired degree of support.

FIG. 1 is an exploded view, generally at 10, of the kit and assembly according to a first variant and which includes a selected hoop shaped component 12 which, as shown, exhibits a generally circular shape and can, without limitation, be constructed of a durable thermoplastic material (e.g. such as by a suitable injection molding operation). The hoop shaped component 12 can further have any polygonal or closed inner facing profile (see surface 14) and may also exhibit flexural properties.

A plurality of vertically integrated and elongated tier defining portions, see four such portions at 16, 18, 20 and 22, are arranged in perimeter defined and integrated fashion about the hoop shaped component 12, such that an intermediate location (see at 17, 19, 21 and 23, respectively) of each tier defining portion is molded or otherwise affixed to such as an outer surface of the hoop shaped component. Without limitation, any sub-plurality of such tier defining portions (two, three, five, etc.) can be provided for each hoop shaped component, these being identically configured in order to provide for modularized stack-ability in order to arrange any number of hoop shaped components in a tiered fashion to maintain a desired supporting arrangement for the growing planting.

The vertically integrated and elongated portions 16, 18, 20 and 22 each further include upper and lower inter-engaging ends, these illustrated in non-limiting example by lower male inserting portions 24, 26, 28 and 30, as well as by upper female socket receiving portions 32, 34, 36 and 38. It is further envisioned and understood that any other interlocking arrangement (such as including tab and slot or other) can be established between the respective upper and lower mounting ends of each tier defining portion without limitation.

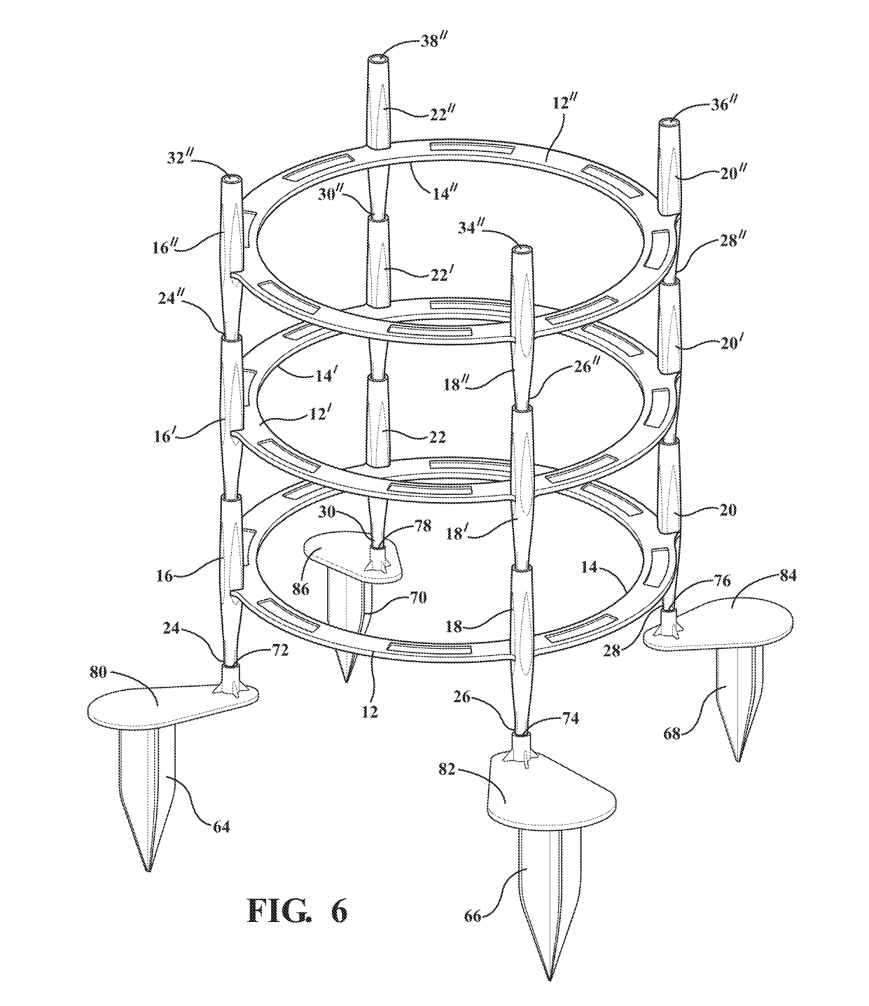

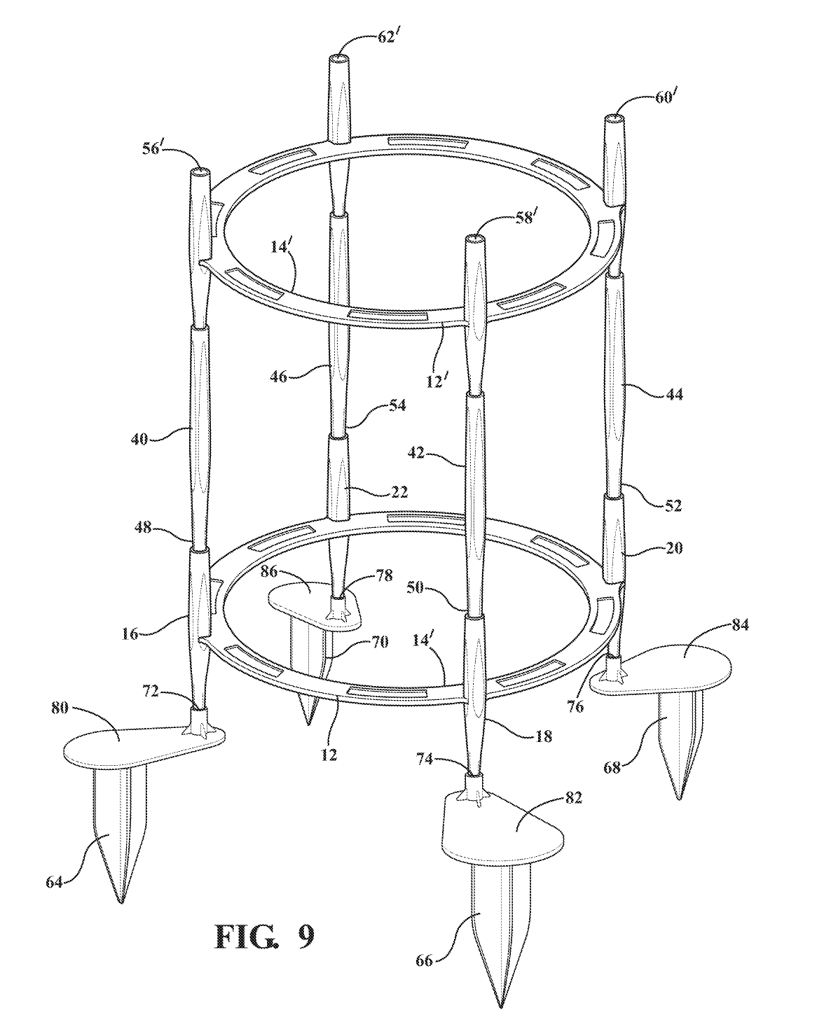

As will be illustrated with reference to the additional drawings, the hoop shaped components can be directly stacked atop one another in multi-tiered fashion (see FIGS. 6-8). As further shown in FIG. 1, an alternate variant includes the provision of a plurality of elongated and height extending portions, see at 40, 42, 44 and 46, interposed between successive aligning and integrated tier defining portions (this shown in FIGS. 9-11) associated with successive and identically configured hoop shaped components, this in order to increase the vertical spacing between respective hoop shaped components. The height extending portions 40, 42, 44 and 46 each include lower end disposed inter-engaging portions (e.g. male inserting portions 48, 50, 52 and 54), as well as upper end disposed female socket portions (at 56, 58, 60 and 62), and so that the height extending portions inter-fit with the inter-engaging ends of the respective tier defining portions.

A first mounting arrangement for a lower most positioned hoop shaped component 12 (again FIG. 1) is further provided by a plurality of feet stakes 64, 66, 68 and 70, these corresponding in number to the given plurality of tier defining portions integrated into the hop shaped component. As shown, the feet stakes can each include an upper end receiving socket (at 72, 74, 76 and 78 respectively) engageable with the lowermost engaging locations (male lower ends 24, 26, 28 and 30) associated with the bottom most tiered hoop shaped component.

Without limitation, the feet stakes 64, 66, 68 and 70 depicted include a flattened intermediate planar surface (at 80, 82, 84 and 86) which separate the lower projecting spike locations (again shown at 64-70) from the upper disposed receiving sockets 72-78. In this fashion, the planar surfaces can provide ease of press embedding (such as by the user's foot) into the turf location associated with a field or garden in which the desired planting is located. It is also understood that the feet stakes can exhibit any other desired shape or configuration without limitation and is understood to not be limited to that depicted herein.

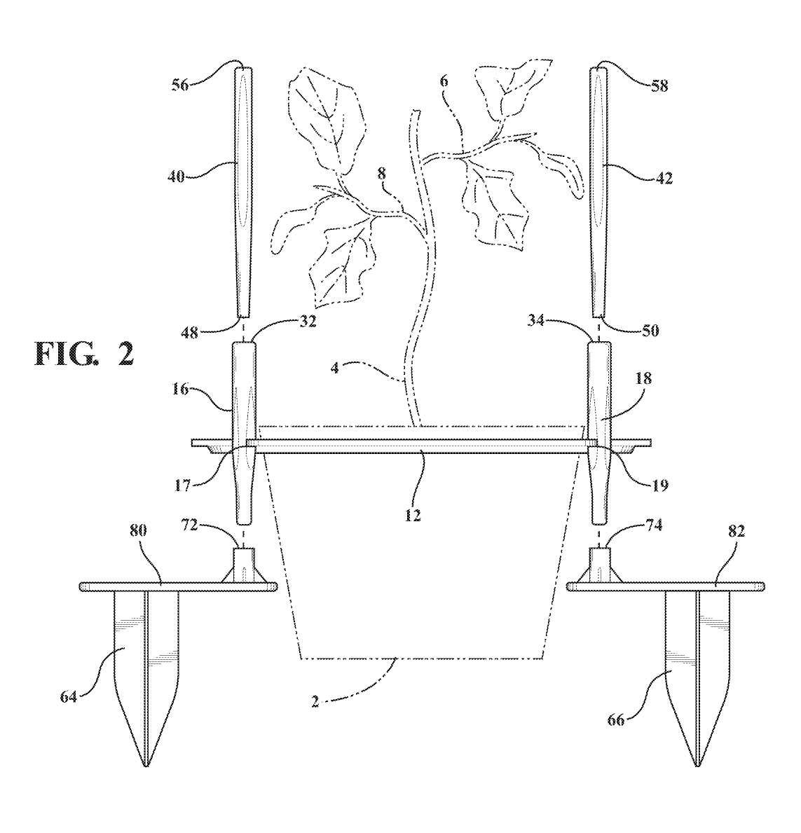

As further shown in corresponding FIG. 2, each of the hoop shaped components can include a disk shape with its inner perimeter rim edge 14 associated with a lower-most hoop component configured to engage a plant bucket 2, illustrated in phantom, the plant bucket having an upper rim location to which the lower-most hoop component can be configured to engage in a further supporting arrangement not requiring the feet stakes. As further shown in FIG. 2, the stem 4 and branches/foliage (collectively referenced at 6 and 8) extend upwardly from the bucket 2 (or ground location) and which are constrained by the tiered hoop shaped components.

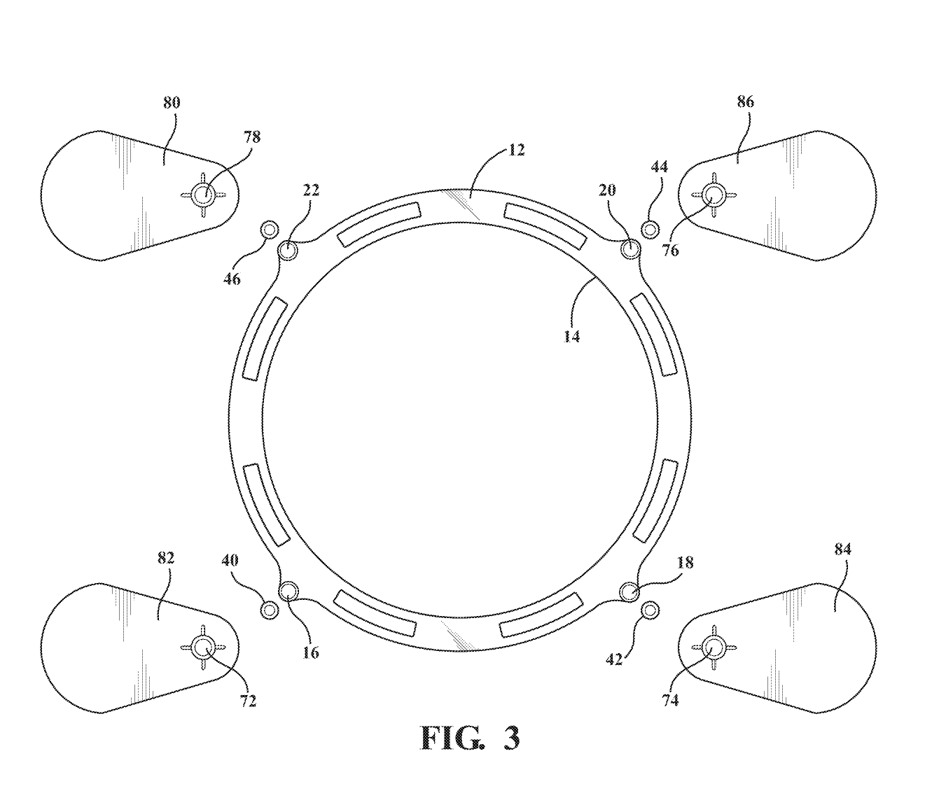

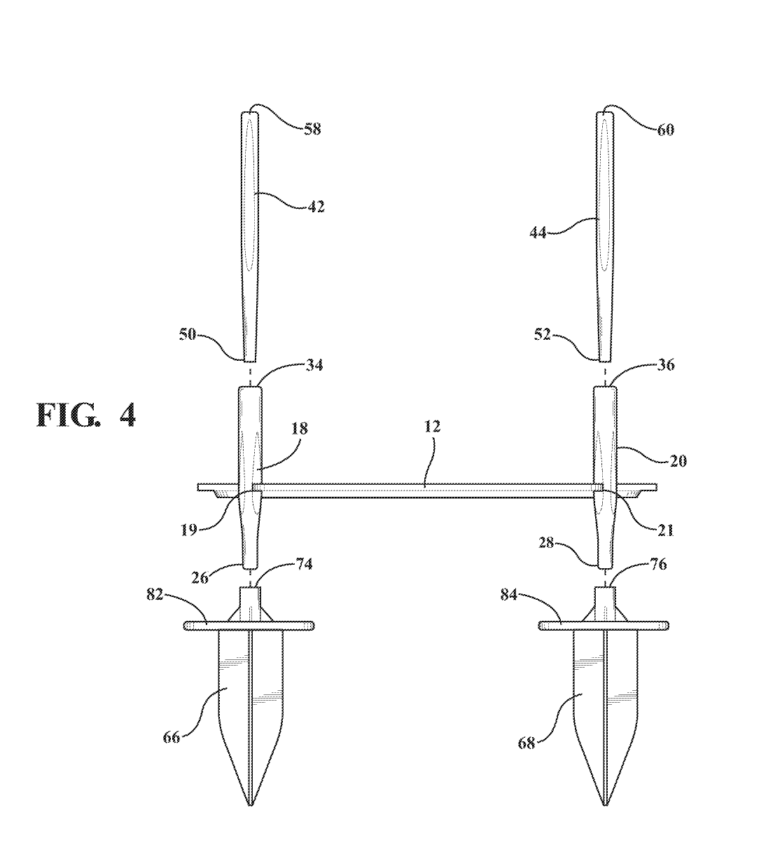

FIG. 3 is a top plan view of the embodiment of FIGS. 1-2 and illustrating the height extending portions and feet stakes positionally radially outwardly from the perimeter of the hoop shaped component for purposes of clarity of presentation. FIG. 4 is a ninety degree rotated side plan view of the exploded embodiment of FIG. 2.

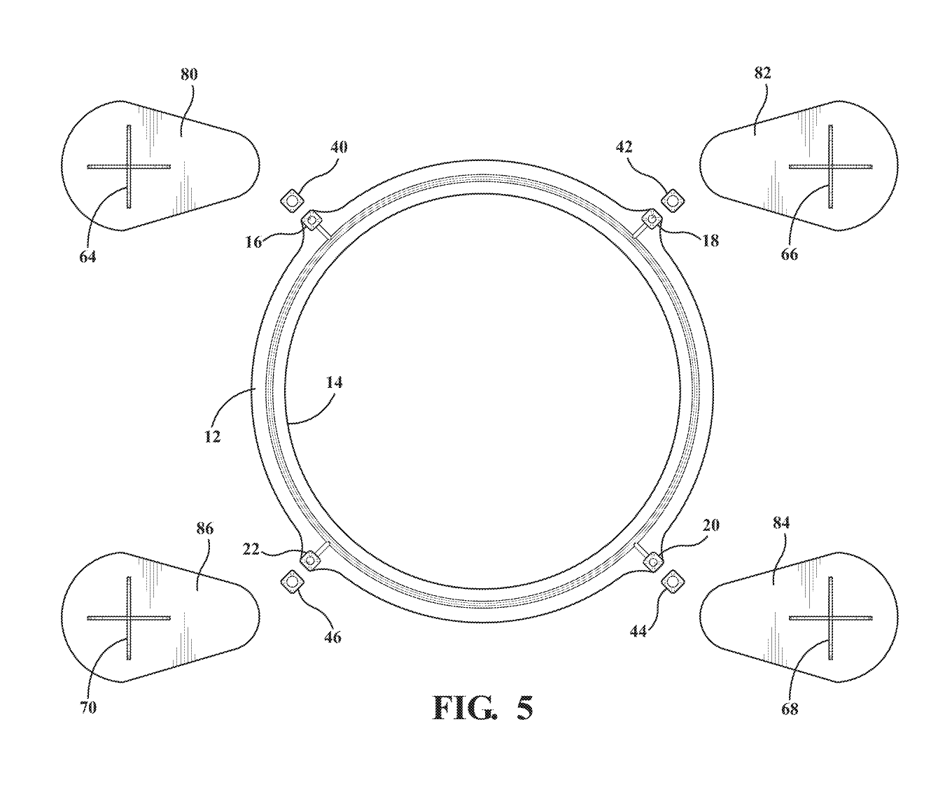

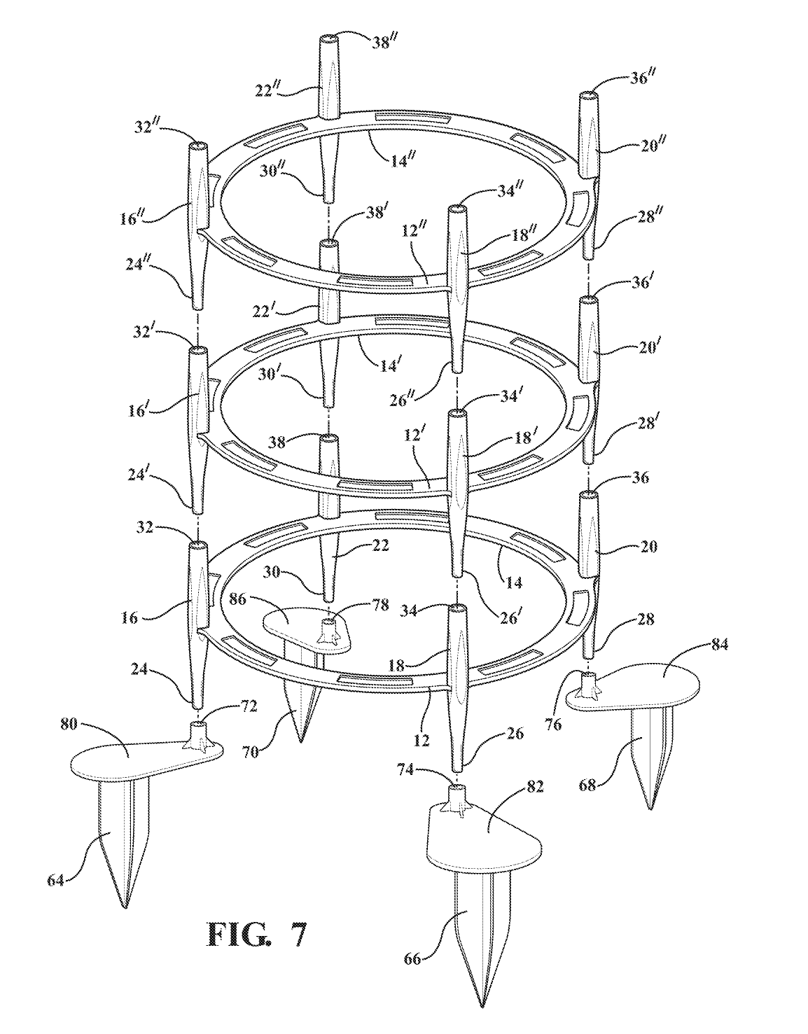

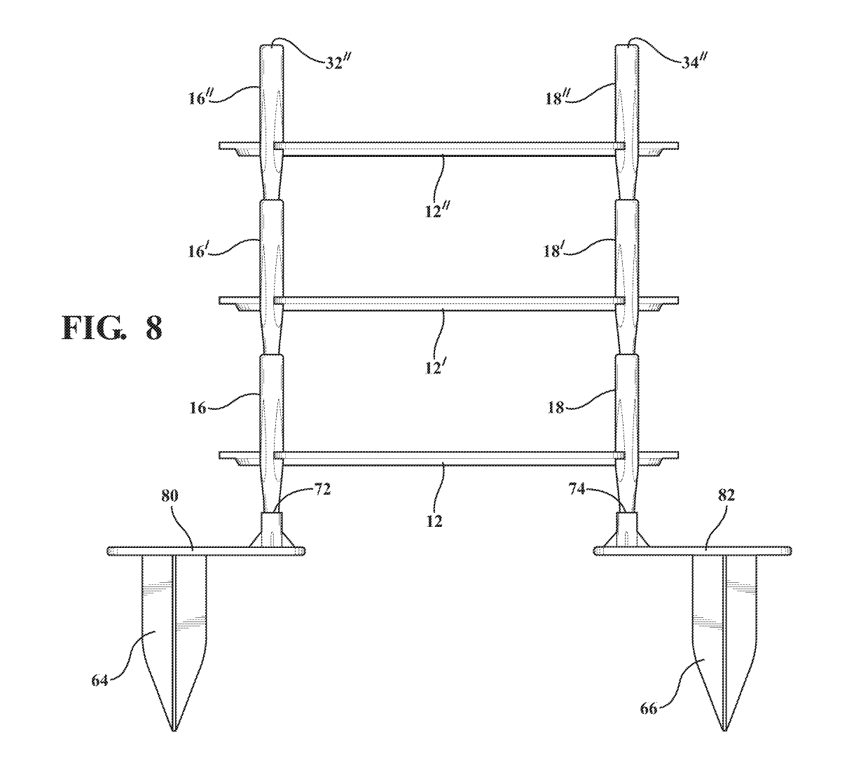

FIG. 5 is a bottom plan view of the embodiments of FIGS. 1-4 and better showing the optional square cross sectional profile associated with the intermediate location of each tier defining portions 16-22 and length extending portion 40-46. FIG. 6 is an assembled perspective view of the modular kit and assembly according to the variant for directly stacking the hoop shaped components one atop another and without use of the intermediate spacers, with FIG. 7 an exploded perspective view of the kit and assembly shown in FIG. 6 and FIG. 8 an assembled front plan view. For purposes of the illustrations, additional tiered hoop shaped components 12′ and 12′ are referenced, along with identical nomenclature associated with the respective identical features of each additional component.

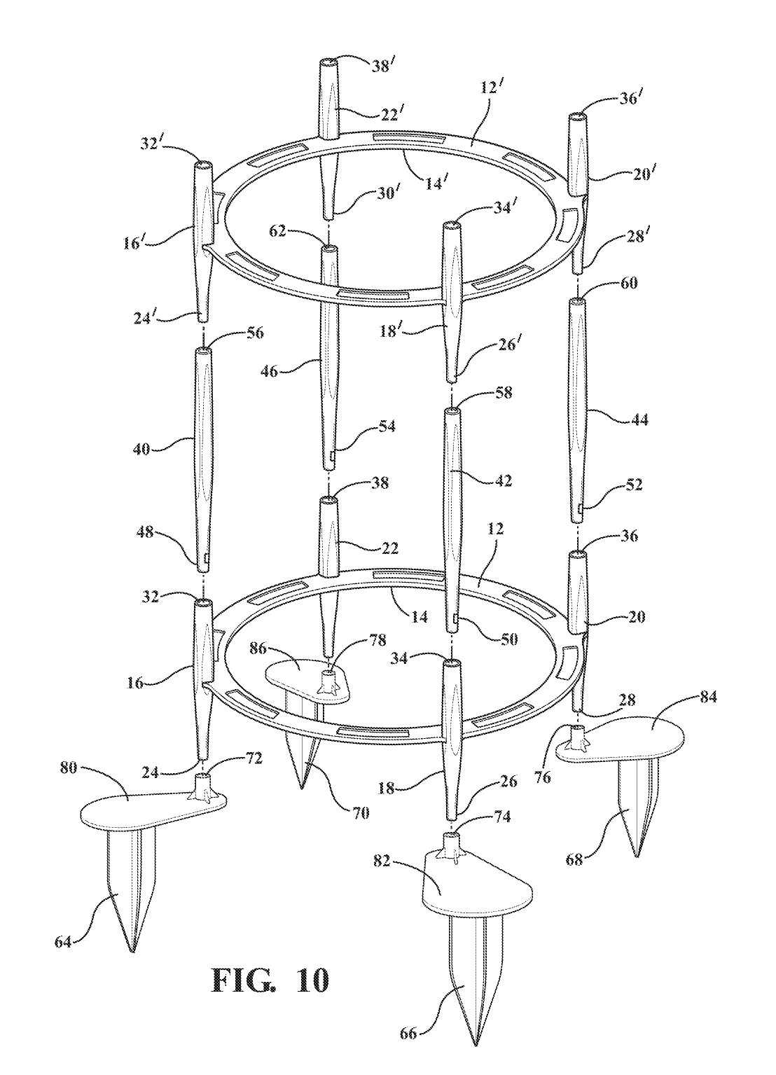

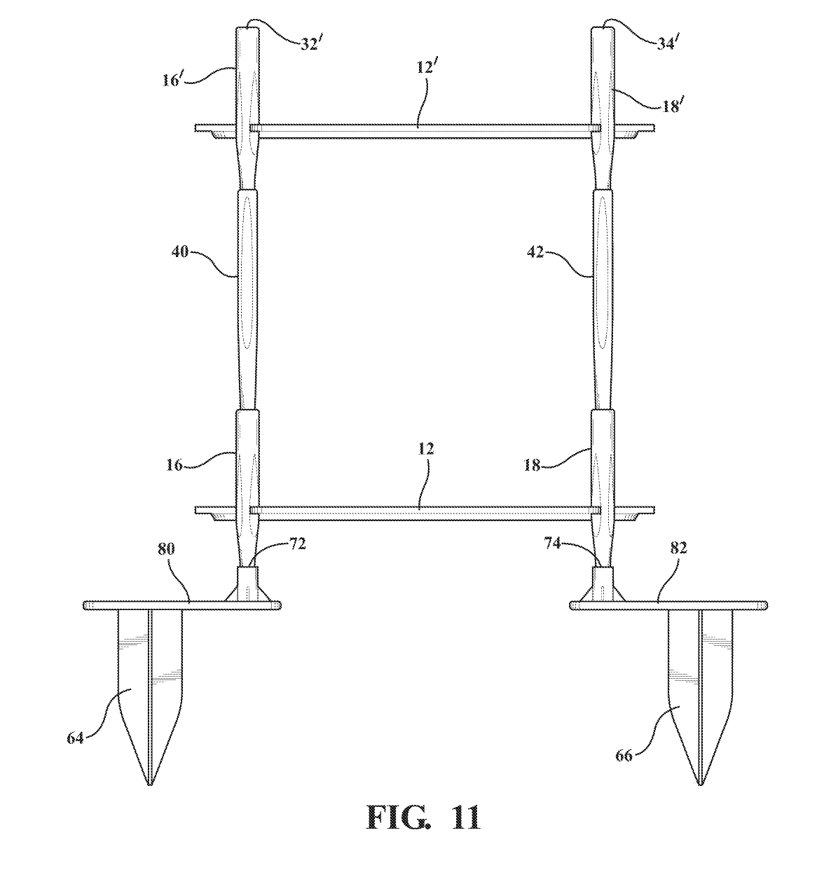

FIG. 9 is an assembled perspective view of the modular kit and assembly according to the variant of FIG. 1 with a second tier defining hoop shaped component. FIG. 10 is an exploded perspective of FIG. 9 and FIG. 11 a plan view illustration of FIG. 10, with the numbering of hoop shaped components 12 and 12′ repeated.

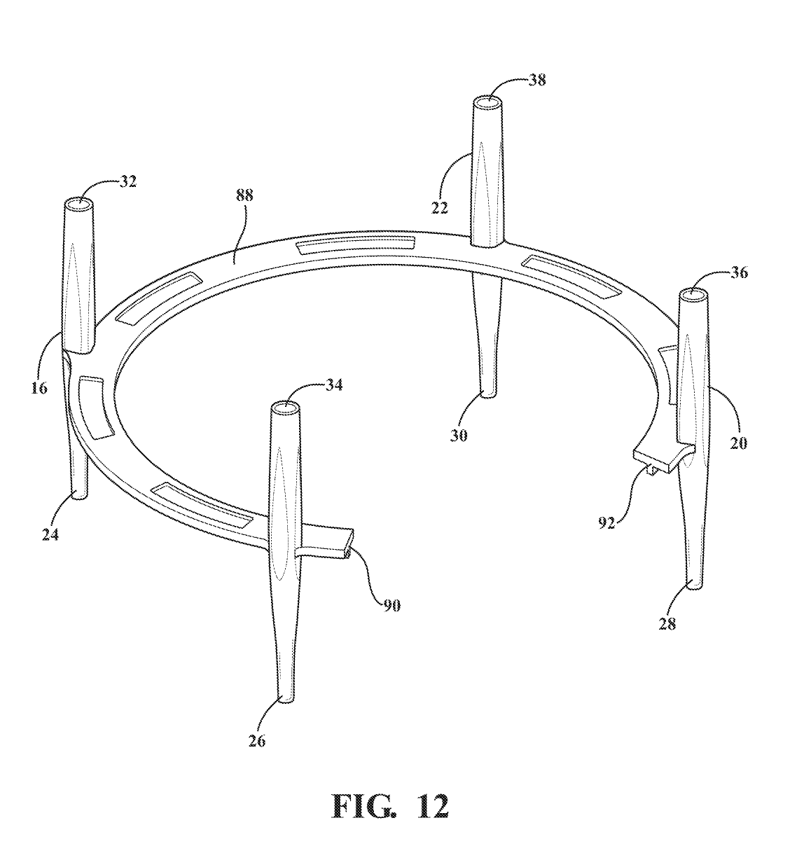

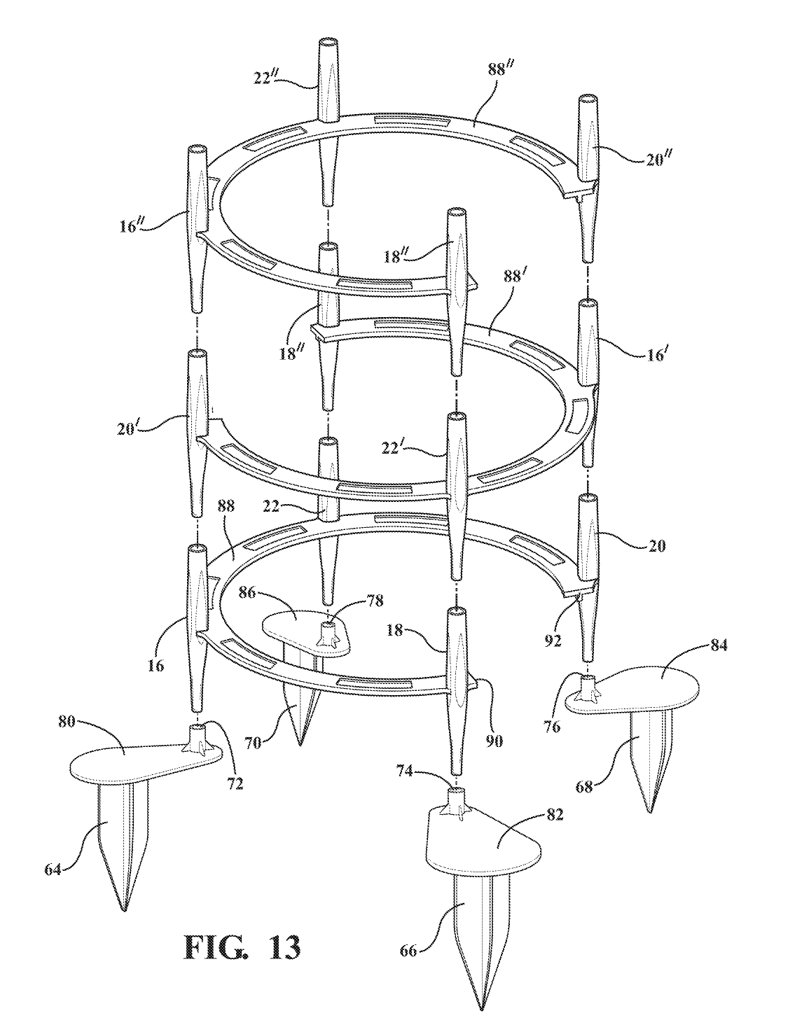

FIG. 12 is a perspective of a further variant of hoop-shaped component 88 exhibiting a partially open profile exhibited by opposing gap surfaces 90 and 92 which therebetween define an open spacing in the perimeter extending hoop. FIG. 13 further provides an exploded perspective view similar to FIG. 7 of a plurality of interconnecting components as shown in FIG. 12, the assembly and operation of which is otherwise unchanged.

As further shown in FIG. 13, the hoop components 88, 88′, 88″, et seq. can be stacked so that the gaps in the hoops can align (such as to more easily facilitate removal of a planting without disassembly of the support. Alternately and as further shown, the hoop shaped components 88, 88′, 88″ can be alternated in some fashion so that the gaps in the components are not aligned. Otherwise, the remaining features, including the elongated tier defining portions, the height extending portions (not shown) and the feet supports are repeated from the previous embodiments and are identically numbered.

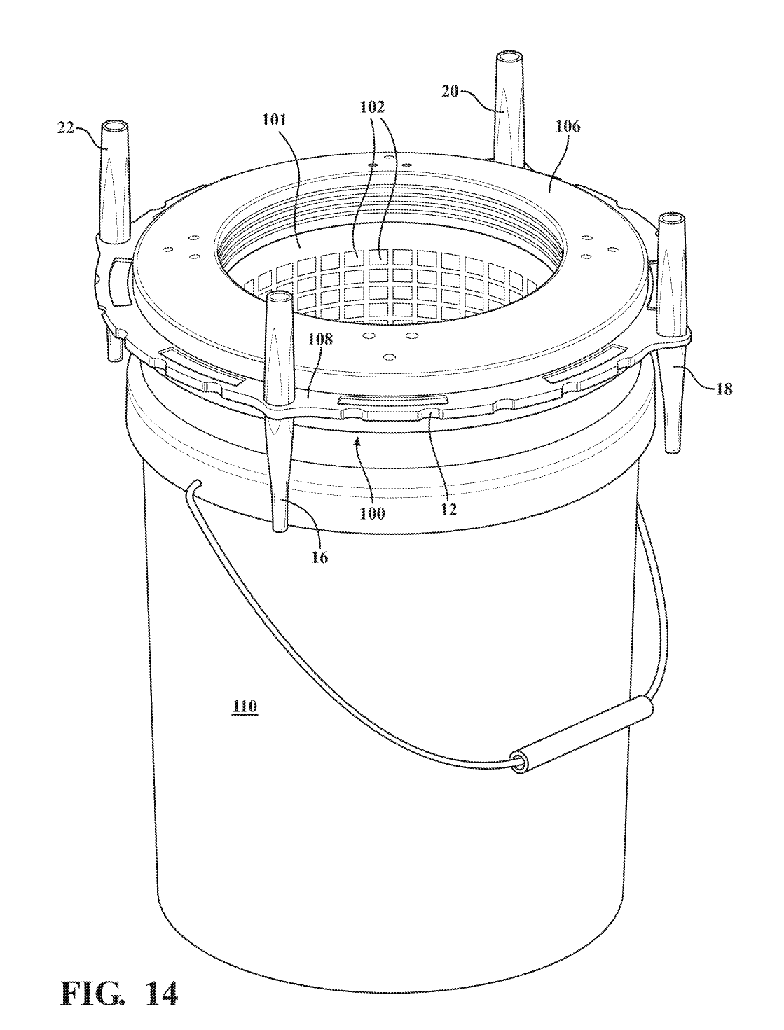

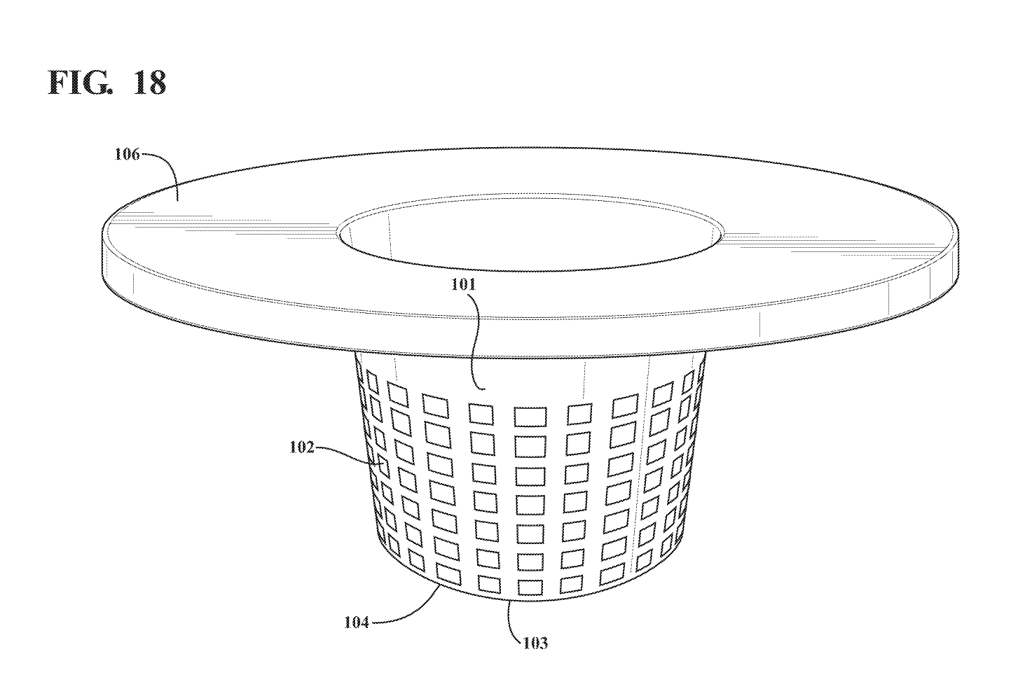

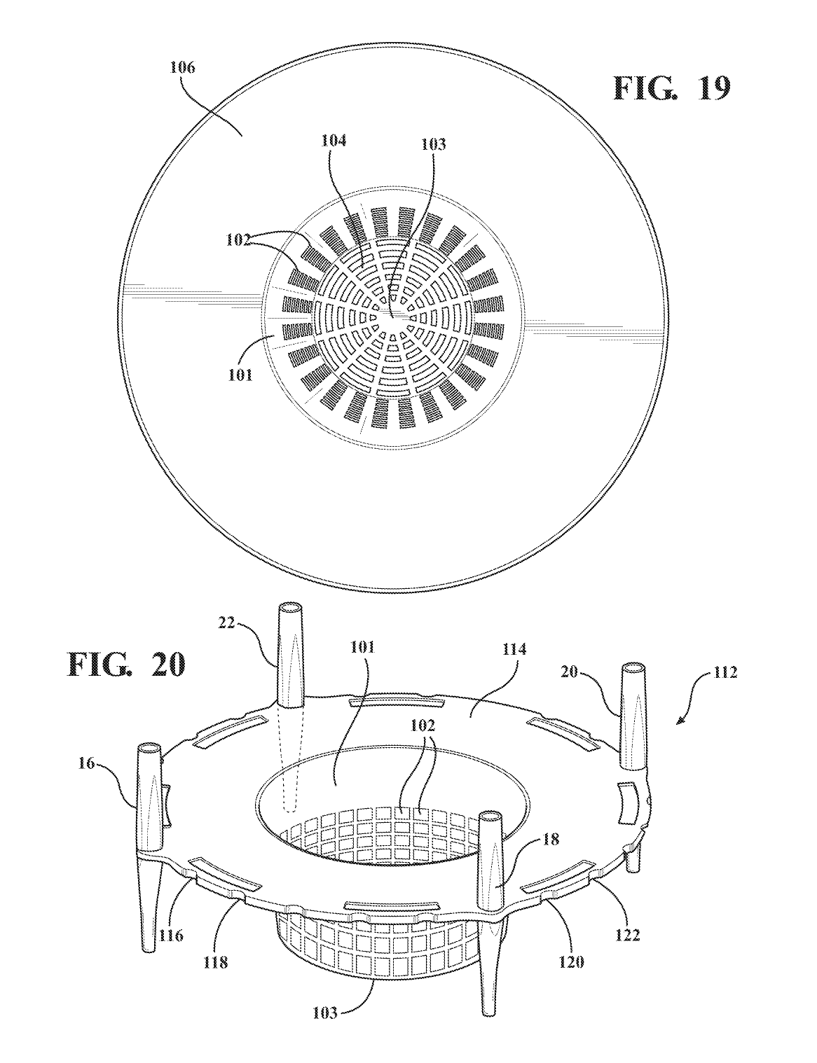

With reference now to FIGS. 14-19, an improved and modified modular kit assembly, see as generally shown at 100, is depicted in particular use with any type of hydroponic growing operation. As will be described in additional detail, the kit assembly includes a colander like basket, this best shown in FIGS. 18-19, the colander basket having an annular flared base 101 within which are configured a plurality of side perforations 102, an interconnecting bottom 103 having additional bottom perforations 104, these in combination collectively defining an aperture and depth extending portion (see FIGS. 18-19) which can mimic any type of net or mesh which allows for free flow therethrough of fluid while maintaining any items placed within the basket. The colander basket is further shown including an annular upper lip 106 extending outwardly from a upper edge of the tapered body 101 which permits the basket to be supported about a rim 108 of a lower-most positioned hoop shaped component, such as according to any of the previously disclosed variants of hoop component collectively referenced in FIGS. 1-13.

Although not shown, it is understood and envisioned that the colander basket (also referred to as a “Net Pot Lid”) can also include any other shape or configuration, such also envisioning the lid or basket being integrated into the lower-most tiered hoop shaped component as a single injection molded or stamped one piece construction. The basket and hoop can be supported (including being snap engaged) upon a standard three or five gallon bucket, see at 110, as well as any other suitable shaped and fluid holding reservoir upon and within which the lower hoop shaped component and integrated colander basket can be placed.

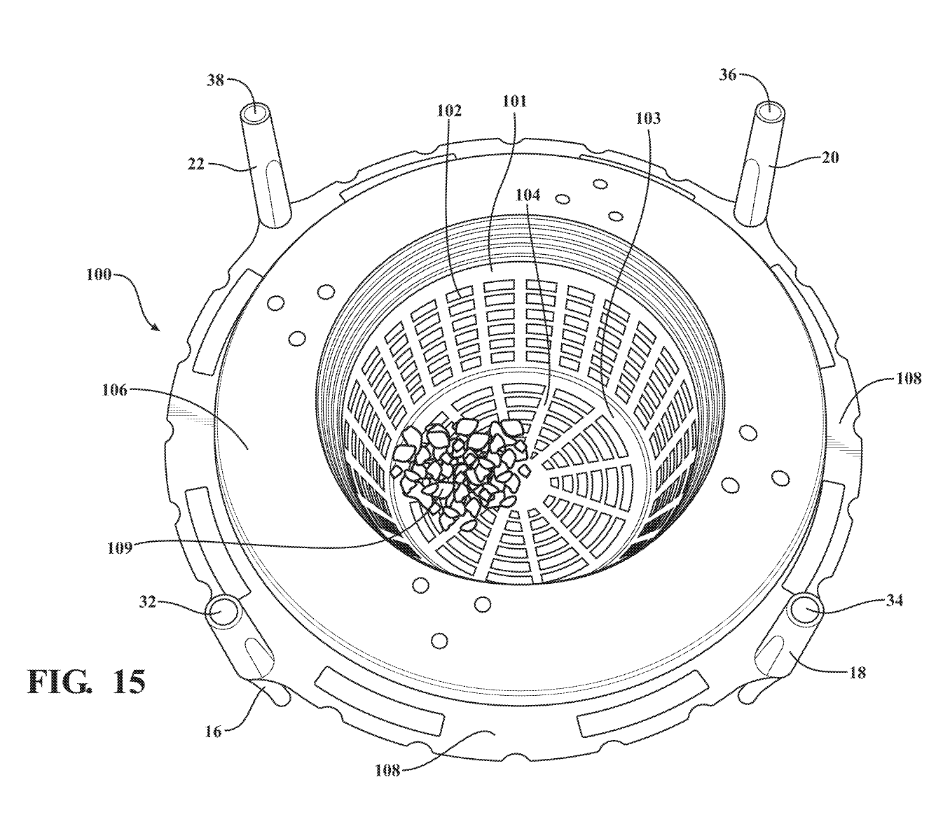

Although not shown, the colander or “basket” (as best depicted in FIG. 18 at 102-106) is filled with a stone or other aggregate media (examples of which are depicted at 109 in FIG. 15), it also being understood that a seedling (see as previously shown at 4 in FIG. 2) is inserted into the stone media. The outer supporting bucket 110 is filled with a water/nutrient mixture (no dirt required) and, with the basket supported upon the lower most positioned hoop 12 and thereby suspended within the nutrient liquid mixture, allowing the seedling to grow hydroponically.

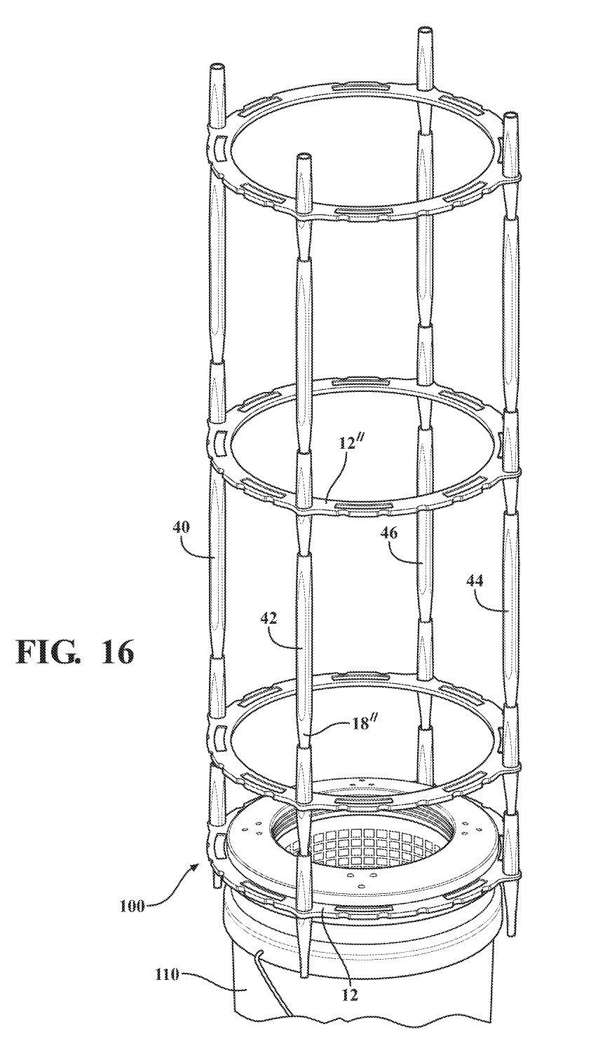

As best depicted in FIG. 16, additional tier defining hoops can beg added, as necessary, to provide an effective hydroponic support system to the growing plant. This can be used in both traditional vegetables, flowers and the medicinal communities and, as previously described, the variant of FIGS. 14-19 can be employed with any version of tier defining hoops as shown in FIGS. 1-13.

As further depicted in FIG. 14, an illustration of a further variant of a combination tiered modular kit assembly includes the lower-most positioned hoop shaped component 12, with the colander like support basket supported upon upper surface 108 of the hoop 12 and the upper rim of the conventional bucket 110 supporting the combination hoop component 12 and colander basket (102-106). The hoop shaped component includes the integrated pedestal support locations which are again depicted at 16-22 (see also FIG. 1).

As best shown in FIG. 14, the arrangement of the vertical supports is such that these are supported outwardly from the rim of the bucket 110. In this fashion, the additional tiers of hoops and inter-attachable vertical spacers (such as shown in FIGS. 6-11) can be assembled upon the lower most hoop 12, such as in a progressive assembling fashion best shown in FIG. 16 to support any continuously hydroponically growing plant (e.g. again as previously shown at 4 in FIG. 2).

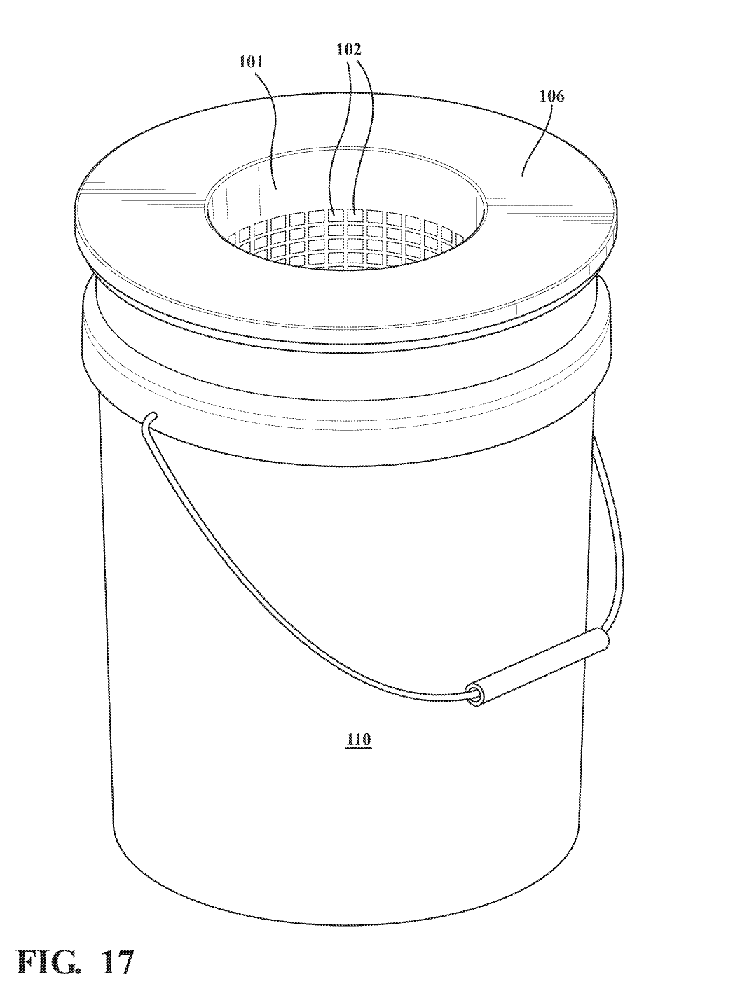

FIG. 17 is a side view of the basket (see annular upper lip 106) supported in suspended fashion upon the bucket 110 interior in an unrelated application, the understanding being that the colander style basket (side 101, bottom 103 and upper annular lip 106) and hoop 12 are typically provided collectively and which can be integrated as a single produced item (such as without limitation by any of stamping or injection molding from a molten thermo-plasticized material).

FIG. 18 again is a perspective view of the colander shaped basket according to one non-limiting embodiment of the present inventions, and which again depicts the annular upper rim 106, which again can either be integrally affixed to or supported upon the upper surface 108 of the hoop shaped component 12. The invention also contemplates the colander basket and associated hoop shaped component (see again at 12) being provided as a snap-fit pair of components, such including suitable tab and slot or other inter-engaging fastener structure for permitting a colander basket to be attached to any selected hoop shaped component as part of a kit assembly.

FIG. 19 is a top plan view of the hydroponic colander basket of FIG. 18 according to any non-limiting construction. It is further understood that the colander (net pot lid) construction can be reconfigured in any manner which allows the planted seedling (such as along with the stones 109 or other aggregate placed within the basket interior) to be suspended within the nutrient liquid mixture filled into the bucket, and again upon the associated (integrally formed or snap-fitted) hoop component 12 being supported upon the outer lip of the bucket in the manner again best shown in 14.

Proceeding to FIG. 20, an illustration is generally shown at 112 of a one piece combination injection molded hoop and colander basket according to a further variant. As previously described, the basket can be either attached to the selected hoop (see again FIG. 15), such as in a snap fit fashion. Alternatively, the basket and hoop can be injection molded or otherwise formed as a single component, again of such as a suitable thermoplastic material.

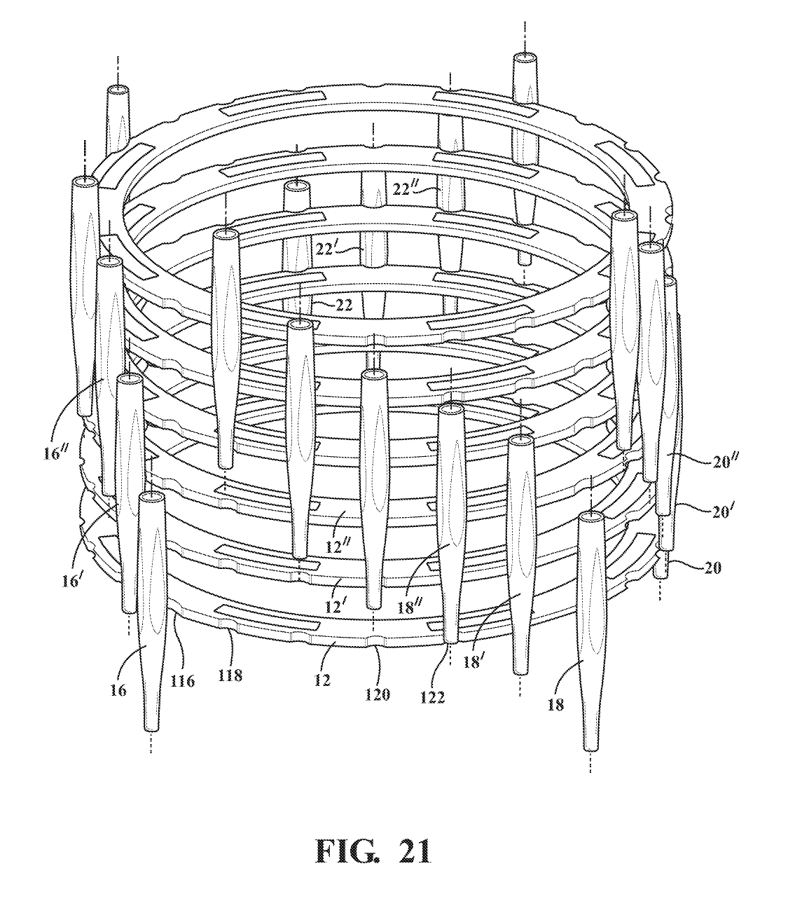

The basket (also termed Net Pot Lid) will again include a sleeve shaped side 101 and interconnected bottom 103 within which are integrated a plurality of apertures 102 for permitting flow through of a hydroponic promoting fluid when the one piece article is supported within the bucket 110. The upper and outer lip of the basket and the hoop are further combined by annular extending portion 114, upon the outside perimeter of which are formed scalloped or semi-circular recessed locations (see selected pairs at 116/118 and 120/122, et. seq. and which are also depicted in FIG. 13 et seq.). As will be described with further reference to FIG. 21, the scalloped locations assist in multiple stacking of the individual hoop sections in a stored configuration. Also integrated into the hoop exterior are elongated tier defining portions 16, 18, 20, and 22 (these also termed stanchion portions).

FIG. 21 is an illustration of a plurality of hoops such as previously depicted in exploded assembled view of FIG. 7, in a multiple-stacked and stored configuration, and in which the integrated tier defining or stanchion portions abut in seating fashion against exterior facing scalloped recesses (again at 116/118, 120/122 et seq.) configured in the outer periphery of the adjoining stacked hoops. In this fashion, the hoops 12, 12′, 12″, et seq. can be stacked in a stored non-use configuration by which the integrated tier defining portions (16, 16′, 16″, et seq., 18, 18′, 18″, et seq., 20, 20′, 20″, et seq., and 22, 22′, 22″, et seq.) telescope past the respective stacked hoops which are position both above and below the specific hoop to which each such stanchion or tier defining portion is integrally attached. As further shown, the stacking arrangement is such that the hoops are partially rotationally offset relative to each other so that the stanchions/tier defining portions, seat against the selected scalloped exterior locations. The stacking arrangement depicted in FIG. 21 is also understood to be equally applicable to stacking the one piece injection molded hoop and basket of FIG. 20, such as apart or in combination with a plurality of the hoops as shown in FIG. 21.

Having described my invention, other and additional preferred embodiments will become apparent to those skilled in the art to which it pertains and without deviating from the scope of the appended claims.

I claim:

1. A kit for providing stem, branch and foliage support for a hydroponic planting, said kit being supported upon a rim of a bucket and comprising:
at least one hoop shaped component exhibiting an open interior;
a basket supported by said hook shaped component so that an apertured and depth extending portion of the basket extends downwardly past its open interior;
a plurality of aggregate, along with a seedling, being placed within said basket aperture interior so that the same is immersed in a liquid filling an interior of the bucket;
each of said hoop shaped components exhibiting a plurality of vertically extending and elongated tier defining portions arranged in perimeter defined fashion about said component, an intermediate location of each of an individual plurality of said tier defining portions being integrated into each of said hoop components; and
each of said elongated tier defining portions further having upper and lower inter-engaging locations and, upon supporting said lower-most hoop shaped component upon the bucket, allowing for stacking of any additional number of said hoop shaped components in vertically spaced apart and tiered defining fashion.

2. The kit as described in claim 1, further comprising elongated and height extending portions interposed between the integrated tier defining portions in order to increase the vertical spacing between said hoop shaped components.

3. The kit as described in claim 1, said upper and lower inter-engaging locations of each of said hoop integrated tier defining components further comprising male and female end configured portions.

4. The kit as described in claim 1, further comprising each of said hoop shaped components having flexural properties.

5. The kit as described in claim 1, said kit components being constructed of an injection molded thermoplastic material.

6. The kit as described in claim 1, further comprising said basket and said hoop shaped component being provided as a single integrated piece.

7. The kit as described in claim 1, said basket further comprising an annular upper lip supported or releasably secured upon an upper surface of said hoop shaped component.

8. The kit as described in claim 1, each of said hoop shaped components further comprising a plurality of outer edge scalloped recess locations, said hoop shaped component being stackable for storage by permitting said tier defining portions of each hoop shaped component to seat against aligning scalloped recess locations configured in adjoining hoop shaped components.

9. A kit for providing stem, branch and foliage support for a hydroponic planting, said kit being supported upon a rim of a bucket and comprising:
at least one hoop shaped component exhibiting an open interior;
a basket supported by said hook shaped component so that an apertured and depth extending portion of the basket extends downwardly past its open interior, said basket having an annular upper lip adapted to being secured to an upper surface of the bucket;
a seedling being placed within said basket aperture interior so that the same is immersed in a liquid filling an interior of the bucket;
each of said hoop shaped components exhibiting at least one vertically extending and elongated tier defining portions arranged in perimeter defined fashion about said component, an intermediate location of each of said tier defining portions being integrated into each of said hoop components; and
each of said elongated tier defining portions further having upper and lower inter-engaging locations and, upon supporting said lower-most hoop shaped component upon the bucket, allowing for stacking of any additional number of said hoop shaped components in vertically spaced apart and tiered defining fashion.

10. The kit as described in claim 9, said upper and lower inter-engaging locations of each of said hoop integrated tier defining components further comprising male and female end configured portions.

11. The kit as described in claim 9, further comprising each of said hoop shaped components having flexural properties.

12. The kit as described in claim 9, said kit components being constructed of an injection molded thermoplastic material.

13. The kit as described in claim 9, further comprising said basket and said hoop shaped component being provided as a single integrated piece.

14. The kit as described in claim 9, said basket further comprising an annular upper lip supported or releasably secured upon an upper surface of said hoop shaped component.

15. The kit as described in claim 9, each of said hoop shaped components further comprising a plurality of outer edge scalloped recess locations, said hoop shaped component being stackable for storage by permitting said tier defining portions of each hoop shaped component to seat against aligning scalloped recess locations configured in adjoining hoop shaped components.

16. A kit for providing stem, branch and foliage support for a hydroponic planting, said kit being supported upon a rim of a bucket and comprising:
at least one hoop shaped component exhibiting an open interior;
a basket supported by said hoop shaped component so that an apertured and depth extending portion of the basket extends downwardly past its open interior;
a plurality of aggregate, along with a seedling, being placed within said basket aperture interior so that the same is immersed in a liquid filling an interior of the bucket;
each of said hoop shaped components exhibiting a plurality of vertically extending and elongated tier defining portions arranged in perimeter defined fashion about said component, an intermediate location of each of an individual plurality of said tier defining portions being integrated into each of said hoop components;
said upper and lower inter-engaging locations of each of said hoop integrated tier defining components further comprising male and female end configured portions;
elongated and height extending portions interposed between the integrated tier defining portions in order to increase the vertical spacing between said hoop shaped components; and
each of said elongated tier defining portions further having upper and lower inter-engaging locations and, upon supporting said lower-most hoop shaped component upon the bucket, allowing for stacking of any additional number of said hoop shaped components in vertically spaced apart and tiered defining fashion.

17. The kit as described in claim 16, each of said hoop shaped components further comprising a plurality of outer edge scalloped recess locations, said hoop shaped component being stackable for storage by permitting said tier defining portions of each hoop shaped component to seat against aligning scalloped recess locations configured in adjoining hoop shaped components.

18. The kit as described in claim 16, further comprising each of said hoop shaped components having flexural properties.

19. The kit as described in claim 16, said kit components being constructed of an injection molded thermoplastic material.

20. The kit as described in claim 16, further comprising said basket and said hoop shaped component being provided as a single integrated piece.
